(19) United States
(12) Patent Application Publication
(10) Pub. No.: US 2015/0109231 A1
(43) Pub. Date: Apr. 23, 2015

(54) CONDUCTIVE FILM FOR TOUCH PANEL AND TOUCH PANEL

(71) Applicant: FUJIFILM Corporation, Tokyo (JP)

(72) Inventors: Hideyuki SHIRAI, Ashigarakami-gun (JP); Yasuhiro OKAMOTO, Ashigarakami-gun (JP); Nobuyuki TADA, Ashigarakami-gun (JP); Yasushi ENDO, Ashigarakami-gun (JP); Toshiaki HAYASHI, Ashigarakami-gun (JP)

(73) Assignee: FUJIFILM Corporation, Tokyo (JP)

(21) Appl. No.: 14/589,447

(22) Filed: Jan. 5, 2015

Related U.S. Application Data
(63) Continuation of application No. PCT/JP2013/068336, filed on Jul. 4, 2013.

(30) Foreign Application Priority Data
Jul. 6, 2012 (JP) 2012-153118
Mar. 18, 2013 (JP) 2013-054843

(51) Int. Cl. G06F 3/044; G06F 3/047; G06F 1/16

(52) U.S. Cl. CPC G06F 3/044; G06F 1/1615; G06F 3/047
USPC 345/173

(57) ABSTRACT

In a conductive film for touch panel, a first electrode pattern is formed on the main surface at one side of an insulating layer, a second electrode pattern is formed on the main surface at the other side of the insulating layer, an adhesive insulating layer is disposed on at least one of the first electrode pattern and the second electrode pattern, an acid value of an adhesive insulating material contained in the adhesive insulating layer is equal to or greater than 10 mg KOH/g and equal to or less than 100 mg KOH/g, either or both of the first electrode pattern and the second electrode pattern contain silver, and a rate of change in mutual capacitance (%) between the first electrode pattern and the second electrode pattern before and after performing an environmental test is 0% to 100%.

### CROSS-REFERENCE TO RELATED APPLICATIONS

This application is a Continuation of PCT International Application No. PCT/JP2013/068336 filed on Jul. 4, 2013, which claims priority under 35 U.S.C. §119(a) to Japanese Application No. 2012-153118 filed on Jul. 6, 2012 and Japanese Application No. 2013-054843 filed on Mar. 18, 2013. Each of the above application(s) is hereby expressly incorporated by reference, in its entirety, into the present application.

### BACKGROUND OF THE INVENTION

The present invention relates to a conductive film for touch panel and a touch panel.

As types of touch panels, a resistive film type touch panel detecting a change in the value of resistance in a touched portion, a capacitance type touch panel detecting a change in capacitance in a touched portion, and an optical sensor type touch panel detecting a change in the amount of light in a touched portion are known.

The capacitance type touch panel includes a self-capacitance type touch panel, a mutual capacitance type touch panel, or the like. In the mutual capacitance type touch panel, for example, longitudinal electrodes (X-electrodes) for transmission and transversal electrodes (Y-electrodes) for reception are arranged in the form of a two-dimensional matrix composed of columns and rows, and for position detection, the capacitance of the electrodes (mutual capacitance) in each node is repeatedly scanned. When a finger touches the surface of the touch panel, the mutual capacitance decreases. Accordingly, by detecting the decrease, an input coordinate is calculated based on a signal showing the change in capacitance in each node.

As a conductive film used in the capacitance type touch panel, for example, JP 4794691 B discloses a conductive film in which two conductive layers are laminated on each other via an adhesive layer such as polyurethane. Moreover, JP 2011-129112 A discloses a conductive sheet suitable for being used in a touch panel.

### SUMMARY OF THE INVENTION

In recent years, in order to meet the demand for the enlargement of touch panel screens, a higher accuracy has been required for performing the position detection.

With reference to the inventions disclosed in JP 4794691 B and JP 2011-129112 A, the present inventors manufactured a conductive film for touch panel using a polyurethane-based adhesive layer. However, as a result of using the obtained conductive film for touch panel as a capacitance type touch panel, they found that operation failure of position detection easily occurs over time, and the accuracy of the position detection does not satisfy the level required nowadays.

The present invention has been made in consideration of the above circumstances, and an object thereof is to provide a conductive film for touch panel that can inhibit the occurrence of operation failure caused over time, and a touch panel that uses the film.

In order to achieve the aforementioned object, the present inventors performed an intensive examination. As a result, they found that the operation failure is caused by the change in mutual capacitance between electrodes in the conductive film. More specifically, they found that the capacitance between electrodes changes over time and deviates from the initial set value, hence the operation failure occurs. Based on the findings, the present inventors continued the examination and found that the aforementioned object can be achieved by the following constitution.

(1) A conductive film for touch panel,

wherein at least one silver halide emulsion layer is formed on each of both surfaces of an insulating layer,

the silver halide emulsion layer formed on each of both surfaces of the insulating layer is exposed to light, then developed, and subjected to a film hardening treatment using a salt containing aluminum atoms, such that a first electrode pattern is formed on the main surface at one side of the insulating layer, and a second electrode pattern is formed on the main surface at the other side of the insulating layer,

an adhesive insulating layer is disposed on at least one of the first electrode pattern and the second electrode pattern,

an acid value of an adhesive insulating material contained in the adhesive insulating layer is equal to or greater than 10 mg KOH/g and equal to or less than 100 mg KOH/g,

either or both of the first electrode pattern and the second electrode pattern contain silver, and

a rate of change in mutual capacitance (%) between the first electrode pattern and the second electrode pattern before and after performing the environmental test described later is 0% to 100%.

(2) The conductive film for touch panel according to (1),

wherein the adhesive insulating layer contains a metal corrosion inhibitor.

(3) A conductive film for touch panel comprising a first electrode pattern, an insulating layer, and a second electrode pattern in this order,

wherein a rate of change in mutual capacitance (%) between the first electrode pattern and the second electrode pattern before and after performing the environmental test described later is 0% to 100%.

(4) The conductive film for touch panel according to (3),

wherein the rate of change in mutual capacitance (%) is 0% to 50%.

(5) The conductive film for touch panel according to (3) or (4), further comprising an adhesive insulating layer on at least one of the first electrode pattern and the second electrode pattern.

(6) The conductive film for touch panel according to any of (3) to (5), further comprising an adhesive insulating layer on the first electrode pattern and the second electrode pattern,

wherein the insulating layer is a non-adhesive insulating layer.

(7) The conductive film for touch panel according to any of (3) to (6),

wherein the insulating layer includes an adhesive insulating layer.

(8) The conductive film for touch panel according to any of (5) to (7),

wherein an adhesive insulating material contained in the adhesive insulating layer includes an acrylic resin.

(9) The conductive film for touch panel according to any of (5) to (8),

wherein an acid value of an adhesive insulating material contained in the adhesive insulating layer is equal to or greater than 10 mg KOH/g and equal to or less than 100 mg KOH/g.

(10) The conductive film for touch panel according to any of (3) to (9),

wherein the insulating layer contains a metal corrosion inhibitor.

(11) The conductive film for touch panel according to (10),

wherein the metal corrosion inhibitor is selected from the group consisting of triazole compounds, tetrazole compounds, benzotriazole compounds, benzimidazole compounds, thiadiazole compounds, and benzothiazole compounds.

(12) The conductive film for touch panel according to any of (3) to (11) that has a water absorption rate of equal to or less than 1.0% when being left to stand in an environment of a temperature of 85° C. and a humidity of 85% for 24 hours.

(13) The conductive film for touch panel according to any of (3) to (12),

wherein either or both of the first electrode pattern and the second electrode pattern contain silver.

(14) The conductive film for touch panel according to any of (3) to (13),

wherein either or both of the first electrode pattern and the second electrode pattern are constituted with thin metal wires having a line width of equal to or less than 30 μm.

(15) A conductive film for touch panel formed in a manner in which a first electrode pattern-equipped insulating layer having the first electrode pattern on one surface of the insulating layer and a second electrode pattern-equipped insulating layer having the second electrode pattern on one surface of the insulating layer are bonded to each other via an adhesive insulating layer, such that the first electrode pattern in the first electrode pattern-equipped insulating layer and the second electrode pattern in the second electrode pattern-equipped insulating layer face each other, or the insulating layer in the first electrode pattern-equipped insulating layer and the second electrode pattern in the second electrode pattern-equipped insulating layer face each other,

wherein each of the first electrode pattern and the second electrode pattern is electrode pattern formed in a manner in which at least one silver halide emulsion layer is formed on the insulating layer, and the silver halide emulsion layer is exposed to light, then developed, and subjected to a film hardening treatment using a polyvalent metal salt, and

a rate of change in mutual capacitance (%) between the first electrode pattern and the second electrode pattern before and after performing the environmental test described later is 0% to 100%.

(16) The conductive film for touch panel according to (15),

wherein the polyvalent metal salt is a salt containing aluminum atoms.

(17) A touch panel comprising the conductive film for touch panel according to any of (1) to (16).

According to the present invention, it is possible to provide a conductive film for touch panels that can inhibit the occurrence of operation failure caused over time and a touch panel that uses the film.

### BRIEF DESCRIPTION OF THE DRAWINGS

FIG. 1A is a plan view of a first embodiment of a conductive film for touch panel of the present invention, and FIG. 1B is a cross-sectional view taken along line A-B of FIG. 1A.

FIG. 2 is a cross-sectional view of a modification example of the first embodiment of the conductive film for touch panel of the present invention.

FIG. 3 is an enlarged plan view of a first electrode pattern of the first embodiment of the conductive film for touch panel of the present invention.

FIG. 4 is a plan view showing an example of the first electrode pattern of the modification example of the first embodiment of the conductive film for touch panel of the present invention.

FIG. 5 is a plan view showing an example of a second electrode pattern of the modification example of the first embodiment of the conductive film for touch panel of the present invention.

FIG. 6 is a plan view showing an example as a combination of the first electrode pattern and the second electrode pattern of the modification example of the first embodiment of the conductive film for touch panel of the present invention.

FIG. 7 is a cross-sectional view of a second embodiment of the conductive film for touch panel of the present invention.

FIG. 8 is a cross-sectional view of a third embodiment of the conductive film for touch panel of the present invention.

FIG. 9 is a cross-sectional view of a fourth embodiment of the conductive film for touch panel of the present invention.

### DETAILED DESCRIPTION OF THE INVENTION

Hereinafter, preferable embodiments of a conductive film for touch panel of the present invention, a manufacturing method thereof, and a touch panel using the conductive film for touch panel of the present invention will be described in detail.

### First Embodiment

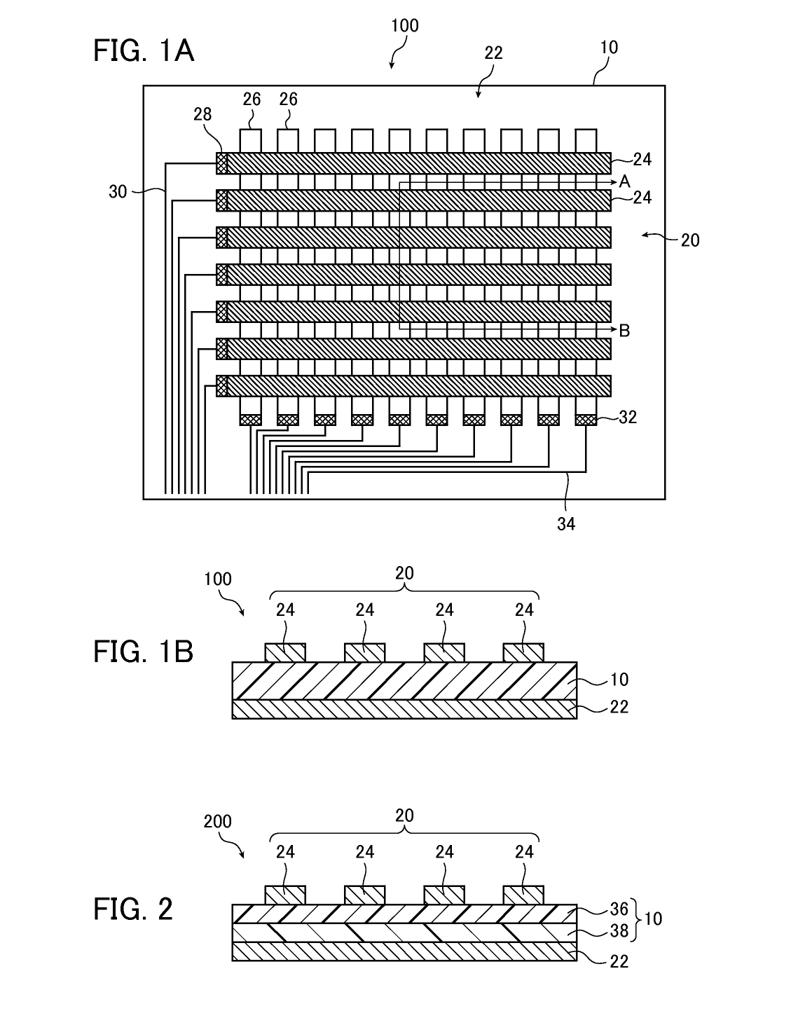

A first embodiment of the conductive film for touch panel of the present invention will be described with reference to the drawings. FIGS. 1A and 1B are schematic views of the first embodiment of the conductive film for touch panel of the present invention. FIG. 1A is a plan view of a conductive film for touch panel 100, and FIG. 1B is a cross-sectional view taken along line A-B of FIG. 1A.

As shown in FIGS. 1A and 1B, the conductive film for touch panel 100 includes an insulating layer 10, a first electrode pattern 20 that is disposed on the main surface at one side of the insulating layer 10, and a second electrode pattern 22 that is disposed on the main surface of the other side of the insulating layer 10.

The first electrode pattern 20 extends in a first direction (X-direction) and includes a plurality of first conductive patterns 24 arranged in a second direction (Y-direction) orthogonal to the first direction. The second electrode pattern 22 extends in the second direction and includes a plurality of second conductive patterns 26 arranged in the first direction.

One end of each of the first conductive patterns 24 is electrically connected to each of first electrode terminals 28. Each of the first electrode terminals 28 is electrically connected to each of first wirings 30 having conductivity. One end of each of the second conductive patterns 26 is electrically connected to each of second electrode terminals 32. Each of the second electrode terminals 32 is electrically connected to each of second wirings 34 having conductivity.

Hereinafter, main members (the insulating layer and the electrode patterns) of the conductive film for touch panel 100 will be described in detail.

(Insulating Layer)

The insulating layer is not particularly limited as long as it is a layer electrically insulating the first electrode pattern from the second electrode pattern. Particularly, the insulating layer is preferably a transparent insulating layer. Specific examples thereof include an insulating resin layer, a ceramic layer, a glass layer, and the like. Among these, an insulating resin layer is preferable since it is excellent in toughness.

The total light transmittance of the insulating layer is preferably 85% to 100%.

The thickness of the insulating layer (when there is a plurality of insulating layers including two or more layers, which is the total thickness thereof) is not particularly limited. However, the thickness is preferably 5 μm to 350 μm, and more preferably 30 μm to 150 μm. If the thickness is within the above range, the intended visible light transmittance is obtained, and it is easy to handle the insulating layer.

The insulating layer may be a layer not having adhesiveness (non-adhesive insulating layer) or a layer having adhesiveness (adhesive insulating layer).

Moreover, the insulating layer may be composed of a single layer or a plurality of layers including two or more layers. As an embodiment in which the insulating layer is composed of a plurality of layers including two or more layers, for example, as shown in FIG. 2, there is an embodiment in which the insulating layer 10 in a conductive film for touch panel 200 has a laminated structure including a non-adhesive insulating layer 36 and an adhesive insulating layer 38.

Hereinafter, embodiments of the non-adhesive insulating layer and the adhesive insulating layer will be described in detail.

As the material constituting the non-adhesive insulating layer, known materials can be used, and preferable examples thereof include non-adhesive insulating resins. More specifically, examples thereof include polyethylene terephthalate, polyether sulfone, polyacrylic resins, polyurethane-based resins, polyester, polycarbonate, polysulfone, polyamide, polyarylate, polyolefin, cellulose-based resins, polyvinyl chloride, and the like. Among these, polyethylene terephthalate is preferable since it is excellent in transparency.

The thickness of the non-adhesive insulating layer is not particularly limited. However, from the viewpoint of balance between impact resistance and lightweight properties, the thickness is preferably 25 μm to 200 μm.

As the material constituting the adhesive insulating layer (hereinafter, also referred to as an “adhesive insulating material”), known adhesives can be used, and examples thereof include rubber-based adhesive insulating materials, acrylic adhesive insulating materials, silicone-based adhesive insulating materials, and the like. Among these, from the viewpoint of excellent transparency, acrylic adhesive insulating materials are preferable.

Moreover, for the reasons that the rate of change in mutual capacitance is further reduced, and migration resistance between conductive patterns become excellent, it is preferable to adopt an embodiment in which the adhesive insulating material is cured by a curing agent. Specific examples of the curing agent include epoxy compounds, isocyanate compounds, or compounds containing atoms that can be coordinated with a metal such as aluminum.

The thickness of the adhesive insulating layer is not particularly limited. However, from the viewpoint of balance between impact resistance and thinning, the thickness is preferably 5 μm to 200 μm.

For the reasons that the rate of change in mutual capacitance is further reduced, and migration resistance between conductive patterns become excellent, an acid value of the adhesive insulating material is preferably equal to or less than 100 mg KOH/g, more preferably 5 mg KOH/g to 100 mg KOH/g, even more preferably 10 mg KOH/g to 100 mg KOH/g, and particularly preferably 15 mg KOH/g to 50 mg KOH/g.

The acid value is measured by neutralization titration method based on JIS K0070:1992 “Test methods for acid value, saponification value, ester value, iodine value, hydroxyl value, and unsaponifiable matter of chemical products.”

The method for manufacturing the acrylic polymer is not particularly limited. Examples thereof include a method in which a predetermined (meth)acrylate compound is put into a reaction apparatus including a stirrer, a reflux condenser, a thermometer, and a nitrogen inlet tube; a polymerization initiator such as azobisisobutyronitrile (AIBN) is added thereto; and polymerization is performed in a nitrogen gas stream for a predetermined time (for example, 8 hours) at a predetermined temperature (for example, 70° C.)

In view of productivity, the adhesive insulating layer is preferably an adhesive insulating sheet. The type of the adhesive insulating sheet is not particularly limited, and for example, it is possible to use commercially available adhesive insulating sheets such as an adhesive sheet NSS50 (manufactured by New Tac Kasei Co., Ltd.) and a highly transparent adhesive transfer tape 8146-2 (manufactured by 3M Company).

The insulating layer (particularly, the adhesive insulating layer) may contain a metal corrosion inhibitor. If the insulating layer contains the metal corrosion inhibitor, the occurrence of operation failure is further inhibited.

The metal corrosion inhibitor is a compound that can form a metal complex film when contacting a metal. Specific examples of the metal corrosion inhibitor include triazole compounds, tetrazole compounds, benzotrizaole compounds, benzimidazole compounds, thiadiazole compounds, benzothiazole compounds, silane coupling agents, and the like. Among these, benzotriazole compounds are preferable since these exert a strong metal corrosion inhibitory effect.

The benzotriazole compounds are compounds having a benzotriazole structure in a molecule. Specific examples of the benzotriazole compounds include 1,2,3-benzotriazole, tolyltriazole, nitrobenzotriazole, alkali metal salts of these, and the like. One kind of the benzotriazole compounds may be used singly, or two or more kinds thereof may be used concurrently.

Among the benzotriazole compounds, 1,2,3-benzotriazole, tolyltriazole, and a sodium salt of benzotrialzole are preferable.

The triazole compounds are compounds having a triazole structure in a molecule. Specific examples of the triazole compounds include 4-amino-1,2,4-triazole, 5-amino-1,2,4-triazole-3-carboxylic acid, 3-mercapto-1,2,4-triazole, alkali metal salts of these, and the like.

The content of the metal corrosion inhibitor in the insulating layer is not particularly limited. However, in view of not causing a problem of precipitation of additives, the content is preferably 0.1% by mass to 3.0% by mass, and more preferably 0.5% by mass to 1.5% by mass, with respect to the total mass of the insulating layer.

(First Electrode Pattern and Second Electrode Pattern)

The first electrode pattern and the second electrode pattern are sensing electrodes that sense the change in electrostatic capacitance in a touch panel including the conductive film for touch panel, and constitute a sensor portion. That is, when a fingertip is brought into contact with the touch panel, the mutual capacitance between the first electrode pattern and the second electrode pattern changes, and based on the amount of change, the position of the fingertip is calculated by an IC circuit.

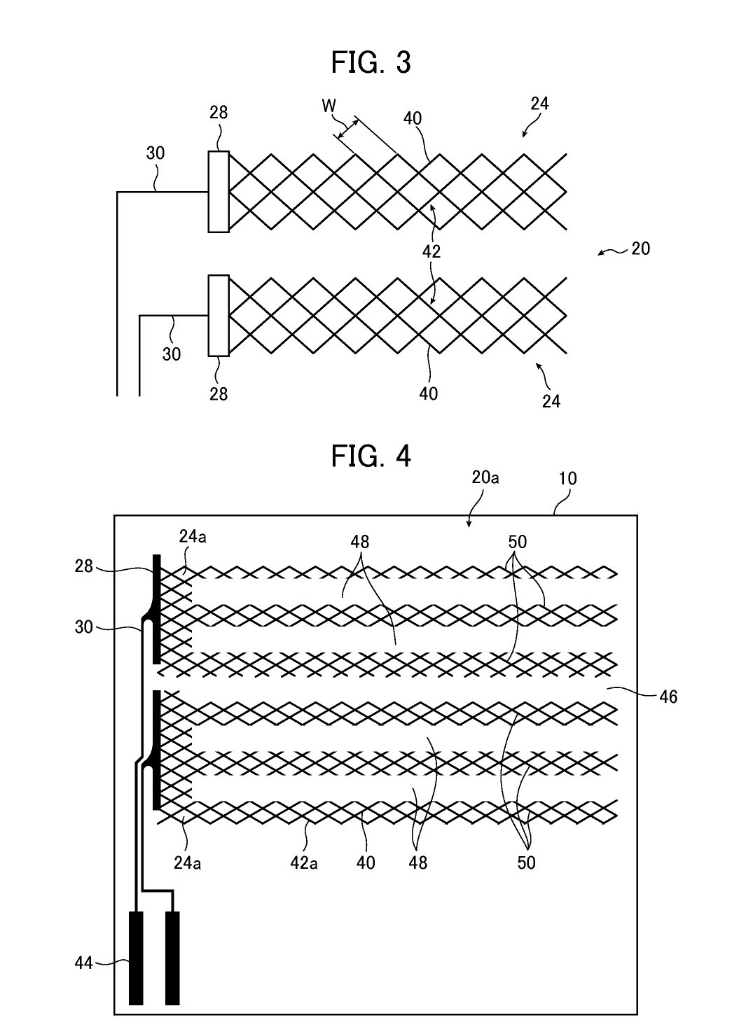

In FIGS. 1A and 1B, the first electrode pattern 20 and the second electrode pattern 22 are constituted with thin conductive wires. FIG. 3 is an enlarged plan view of the first electrode pattern 20. As shown in FIG. 3, the first conductive patterns 24 of the first electrode pattern 20 are constituted with thin conductive wires 40, and include a plurality of lattices 42 formed by the thin conductive wires 40 crossing each other. Herein, similarly to the first electrode pattern 20, the second electrode pattern 22 also includes a plurality of lattices formed by the thin conductive wires crossing each other.

Each of the lattices 42 includes an opening region surrounded by the thin conductive wires 40. A length W of one side of each of the lattices 42 is preferably equal to or less than 800 μm, more preferably equal to or less than 600 μm, and even more preferably equal to or less than 400 μm.

In view of visible light transmittance, the opening ratio in the first conductive patterns 24 and the second conductive patterns 26 is preferably equal to or higher than 85%, more preferably equal to or higher than 90%, and most preferably equal to or higher than 95%. The opening ratio corresponds to a proportion of a transmitting portion, excluding the thin conductive wires of the first conductive patterns 24 or the second conductive patterns 26 in a predetermined region, in the entire region.

In the conductive film for touch panel 100, the lattices 42 have the shape of approximate to a rhombus. However, the lattices 42 may also have the shape of a polygon (for example, a triangle, a quadrangle, or a hexagon). Moreover, one side of each of the lattices may be in the form of a curved line or an arc in addition to the form of a straight line. When one side of each of the lattices is in the form of an arc, for example, two sides facing each other may be in the form of arcs curving toward the outside, and the other two sides facing each other may be in the form of arcs curving toward the inside. Furthermore, each side of the lattices may be in the form of a wavy line in which an arc curving toward the outside and an arc curving toward the inside continue. Needless to say, each side of the lattices may form a sine curve.

Examples of the material of the thin conductive wires include metals such as gold (Au), silver (Ag), and copper (Cu), metal oxides such as tin oxide, zinc oxide, cadmium oxide, gallium oxide, and titanium oxide, and the like. Among these, silver is preferable since conductivity of the thin conductive wires becomes excellent.

From the viewpoint of the adhesiveness between the thin conductive wire and the insulating layer, the thin conductive wires preferably contain a binder.

The binder is preferably a water-soluble polymer since the adhesiveness between the thin conductive wire and the insulating layer is further improved. Examples of the types of the binder include polysaccharides such as gelatin, carrageenan, polyvinyl alcohol (PVA), polyvinylpyrrolidone (PVP), and starch, cellulose and derivatives thereof, polyethylene oxide, polysaccharide, polyvinyl amine, chitosan, polylysine, polyacrylic acid, polyalginic acid, polyhyaluronic acid, carboxycellulose, gum Arabic, sodium alginate, and the like. Among these, gelatin is preferable since the adhesiveness between the thin conductive wire and the insulating layer is further improved.

Herein, as gelatin, in addition to lime-treated gelatin, acid-treated gelatin may be used. Moreover, it is possible to use a hydrolysate of gelatin, an enzymatic decomposition product of gelatin, and gelatin modified with an amino group or a carboxyl group (phthalated gelatin or acetylated gelatin).

The volume ratio between a metal and a binder (volume of metal/volume of binder) in the thin conductive wires is preferably equal to or higher than 1.0, and more preferably equal to or higher than 1.5. If the volume ratio between a metal and a binder is equal to or higher than 1.0, the conductivity of the thin conductive wires can be further improved. The upper limit of the volume ratio is not particularly limited. However, from the viewpoint of productivity, the upper limit is preferably equal to or less than 4.0, and more preferably equal to or less than 2.5.

In the present invention, the volume ratio between a metal and a binder can be calculated from the density of the metal and the binder contained in the thin conductive wires. For example, when the metal is silver and the binder is gelatin, the volume ratio is calculated under the conditions of the density of silver at 10.5 g/cm³ and the density of gelatin at 1.34 g/cm³.

The line width of the thin conductive wires is not particularly limited. However, from the viewpoint of making it possible to relatively easily form electrodes having low resistance, the line width is preferably equal to or less than 30 μm, more preferably equal to or less than 15 μm, even more preferably equal to or less than 10 μm, particularly preferably equal to or less than 9 μm, and most preferably equal to or less than 7 μm. The line width is preferably equal to or greater than 0.5 μm, and more preferably equal to or greater than 1.0 μm.

The thickness of the thin conductive wires is not particularly limited. However, from the viewpoint of conductivity and visibility, the thickness can be selected within a range of 0.001 mm to 0.2 mm. The thickness is preferably equal to or less than 30 μm, more preferably equal to or less than 20 μm, even more preferably 0.01 μm to 9 μm, and most preferably 0.05 μm to 5 μm.

As the material of the first electrode pattern and the second electrode pattern (material of the thin conductive wires), a metal nanowire may be used, since the value of surface resistance thereof is lower than that of a metal oxide such as ITO, and a transparent conductive layer is easily formed. As the metal nanowire, fine metal particles are preferable which have an aspect ratio (average major-axis length/average minor-axis length) of equal to or higher than 30, an average minor-axis length of equal to or greater than 1 nm and equal to or less than 150 nm, and an average major-axis length of equal to or greater than 1 μm and equal to or less than 100 μm. The average minor-axis length of the metal nanowire is preferably equal to or less than 100 nm, more preferably equal to or less than 30 nm, and even more preferably equal to or less than 25 nm. The average major-axis length of the metal nanowire is preferably equal to or greater than 1 μm and equal to or less than 40 μm, more preferably equal to or greater than 3 μm and equal to or less than 35 μm, and even more preferably equal to or greater than 5 μm and equal to or less than 30 μm.

The metal constituting the metal nanowire is not particularly limited. As the metal, one kind of metal may be used singly, or two or more kinds of metals may be used in combination. Alternatively, an alloy can be used. Specific examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, an alloy of these, and the like. It is preferable to use a silver nanowire in which the content of silver is equal to or greater than 50% in terms of mass ratio.

(Manufacturing Method of Metal Nanowire)

The metal nanowire may be prepared by any method. The manufacturing method of the metal nanowire is described in detail in, for example, Adv. Mater. Vol. 14, 2002, 833-837, JP 2010-084173 A, and US 2011/0174190 A. Examples of documents relating to the metal nanowire include JP 2010-86714 A, JP 2010-87105 A, JP 2010-250109 A, JP 2010-250110 A, JP 2010-251611 A, JP 2011-54419 A, JP 2011-60686 A, JP 2011-65765 A, JP 2011-70792 A, JP 2011-86482 A, and JP 2011-96813 A. In the present invention, the content disclosed in these documents can be used in combination as appropriate.

(Conductive Film for Touch Panel)

In the conductive film for touch panel, a rate of change in mutual capacitance (%) between the first electrode pattern and the second electrode pattern before and after performing the following environmental test is 0% to 100%. The rate of change is preferably 0% to 80%, more preferably 0% to 60%, even more preferably 0% to 50%, and particularly preferably 0% to 40%. If the rate of change in mutual capacitance (%) is within the certain range described above, when the conductive film is used as a touch panel, the operation failure caused over time is inhibited.

In the environmental test, the conductive film for touch panel is left to stand in an environment of a temperature of 85° C. and a humidity of 85% for 30 days. A mutual capacitance X between the first electrode pattern and the second electrode pattern having not yet been subjected to the environmental test is measured (measurement conditions: temperature of 25° C., humidity of 50%), and a mutual capacitance Y between the first electrode pattern and the second electrode pattern having been subjected to the environmental test is measured. The rate of change in mutual capacitance is calculated by the following equation.

Rate of change in mutual capacitance (%)=(Y−X)/X×100

Herein, the mutual capacitance between the first thin conductive wire and the second thin conductive wire is measured by an LCR meter.

In addition, for the reason that the rate of change in mutual capacitance is further reduced, and migration resistance of the thin conductive wires becomes excellent, a water absorption rate of the conductive film for touch panel, which is left to stand in an environment of a temperature of 85° C. and a humidity of 85% for 24 hours, is preferably equal to or less than 1.00%, more preferably 0% to 0.95%, even more preferably 0% to 0.90%, particularly preferably 0% to 0.85%, and most preferably 0% to 0.80%. If the water absorption rate is within the certain range described above, moisture is not easily absorbed into the conductive film even in a high-temperature high-humidity environment, and the change in mutual capacitance is inhibited. Accordingly, the rate of change in mutual capacitance falls within the certain range described above. As a result, when the conductive film is used as a touch panel, the operation failure caused at the time of position detection is further inhibited.

The water absorption rate is calculated as below.

The obtained conductive film for touch panel is left to stand in an environment of a temperature of 85° C. and a humidity of 85% for 24 hours and then weighed (the mass obtained in this manner is named W1). Thereafter, the conductive film is dried in an environment of a temperature of 110° C. for 24 hours and then weighed (the mass obtained in this manner is named W2). The water absorption rate of the conductive film for touch panel is calculated by the following equation.

Water absorption rate of conductive film for touch panel (%)=(W1−W2)/W2×100

The surface resistance of the first electrode pattern and the second electrode pattern of the conductive film for touch panel is preferably equal to or less than 100 ohm/sq., more preferably equal to or less than 80 ohm/sq., even more preferably equal to or less than 60 ohm/sq., and particularly preferably equal to or less than 40 ohm/sq. The lower the lower limit value of the surface resistance, the better. Generally, a value of 0.01 ohm/sq. is sufficient as the lower limit, and depending on the purpose, the conductive film can be used even if the lower limit is 0.1 ohm/sq. or 1 ohm/sq.

If necessary, the conductive film for touch panel may include other layers (for example, an undercoat layer and an anti-halation layer) between the insulating layer and the first electrode pattern (or the second electrode pattern).

The undercoat layer is a layer provided to further improve the adhesiveness between the insulating layer and the thin conductive wire constituting the first electrode pattern or the second electrode pattern. The material constituting the undercoat layer is not particularly limited, and examples thereof include the aforementioned binders.

The material used for the anti-halation layer and how to use the material are not particularly limited and described in, for example, paragraphs [0029] to [0032] of JP 2009-188360 A.

(Manufacturing Method)

The manufacturing method of the conductive film for touch panel is not particularly limited, and known methods can be adopted.

For example, a resist pattern may be formed by performing an exposure and development treatment on a photoresist film on metal foil formed on both the main surfaces of the insulating layer; the metal foil exposed through the resist pattern may be etched; whereby the first electrode pattern and the second electrode pattern may be formed.

Alternatively, paste containing fine metal particles may be printed on both of the main surfaces of the insulating layer; the paste may be plated with a metal; whereby the first electrode pattern and the second electrode pattern may be formed.

Moreover, the first electrode pattern and the second electrode pattern may be formed on the insulating layer by printing by using a screen printing plate or a gravure printing plate. Alternatively, the first electrode pattern and the second electrode pattern may be formed by an ink jet.

Furthermore, in addition to the aforementioned methods, for example, a method of using silver halide may be used, and this method will be explained in detail in a fifth embodiment which will be described later.

### Modification Example of First Embodiment

The first embodiment is not limited to the embodiment shown in FIGS. 1A and 1B, and another embodiment may be adopted as long as the rate of change in mutual capacitance is within a predetermined range.

For example, as another embodiment, an embodiment may be adopted in which the main surface at one side of the insulating layer includes a plurality of belt-like first electrode patterns arranged in a state of being parallel to each other; and the main surface at the other side of the insulating layer includes a plurality of belt-like second electrode patterns approximately orthogonal to the first electrode patterns and arranged in a state of being parallel to each other. The first electrode patterns and the second electrode patterns may be in the form of a slender and long rectangle or in the form of a so-called diamond pattern in which diamond shapes continue in series. The first electrode patterns and the second electrode patterns are constituted with thin metal wires and may be mesh patterns or stripe patterns. The opening of the mesh may be in the form of a square, a rhombus, a hexagon, and the like.

Hereinafter, by using FIGS. 4 to 6, the conductive film for touch panel according to a modification example of the first embodiment will be more specifically described.

FIG. 4 shows a first electrode pattern 20a on the insulating layer 10. The first electrode pattern 20a includes two first conductive patterns 24a constituted with a large number of lattices 42a formed by thin conductive wires 40. One end of each of the first conductive patterns 24a is electrically connected to each of the first electrode terminals 28. Moreover, each of the first electrode terminals 28 is electrically connected to one end of each of first wirings 30. The other end of each of the first wirings 30 is electrically connected to each of terminals 44. The first conductive patterns 24a are electrically separated from each other by a first nonconductive pattern 46.

The first conductive patterns 24a extend in a first direction (X-direction) and are arranged in parallel. Each of the first conductive patterns 24a includes slit-like nonconductive patterns 48 electrically separated from each of the first conductive patterns 24a. Furthermore, each of the first conductive patterns 24a includes a plurality of first conductive pattern lines 50 divided by each of the nonconductive patterns 48.

As shown in FIG. 4, having the slit-like nonconductive patterns 48 of which one end is opened the first conductive patterns 24a form a comb-like structure in FIG. 4. In this embodiment, each of the first conductive patterns 24a has two nonconductive patterns 48, and accordingly, three first conductive pattern lines 50 are formed. The number of the first conductive pattern lines 50 is not limited to three. Because the respective first conductive pattern lines 50 are connected to the first electrode terminal 28, they have the same potential.

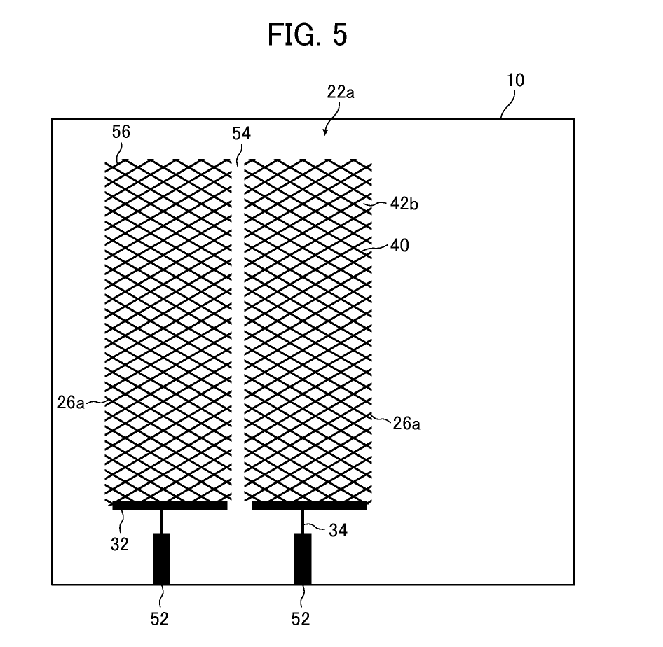

FIG. 5 shows a second electrode pattern 22a on the insulating layer 10. As shown in FIG. 5, the second electrode pattern 22a is constituted with a large number of lattices 42b formed by the thin conductive wires 40. The second electrode pattern 22a extends in a second direction (Y-direction) orthogonal to a first direction (X-direction) and includes two second conductive patterns 26a arranged in parallel. Each of the second conductive patterns 26a is electrically connected to each of second electrode terminals 32. Each of the second electrode terminals 32 is electrically connected to one end of each of second wirings 34. The other end of each of the second wirings 34 is electrically connected to each of terminals 52. The second conductive patterns 26a are electrically separated from each other by a second nonconductive pattern 54. Each of the second conductive patterns 26a has a rectangular structure having a substantially consistent width along the second direction. Here, each of the second conductive patterns 26a is not limited to be in the form of the rectangle.

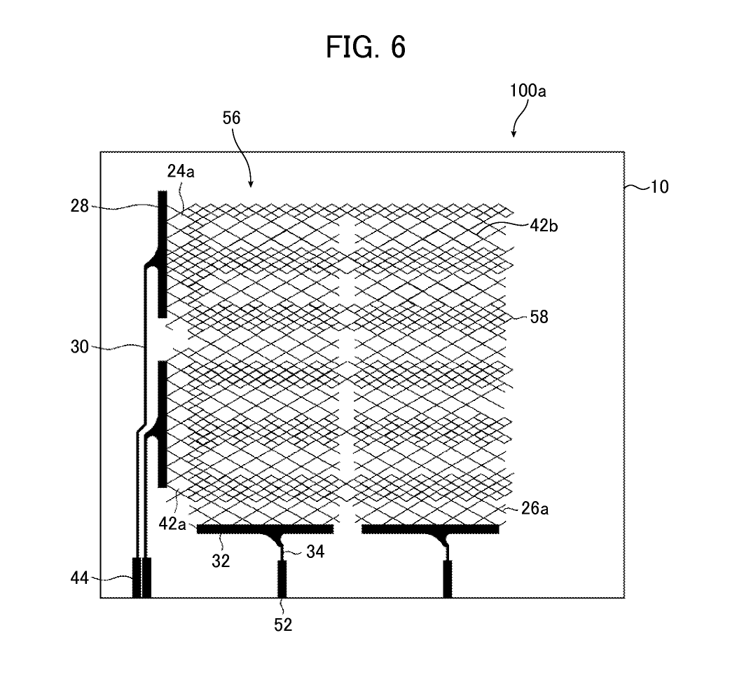

FIG. 6 is a plan view of a conductive film for touch panel 100a in which the first electrode pattern 20a including the first conductive patterns 24a having a comb-like structure and the second electrode pattern 22a including the second conductive patterns 26a having a rectangular structure are arranged such that the first conductive patterns 24a and the second conductive patterns 26a become orthogonal to each other. By the first electrode pattern 20a and the second electrode pattern 22a, a combination pattern 56 is formed.

When seen in a top view, small lattices 58 are formed in the combination pattern 56 by the lattices 42a and the lattices 42b. That is, the crossing portion of the lattices 42a is disposed substantially at the center of the opening region of the lattices 42b. Herein, the length of one side of each of the small lattices 58 is equal to or greater than 200 μm and equal to or less than 400 μm, and is preferably equal to or greater than 200 μm and equal to or less than 300 μm. This is a length which is a half of the length of one side of each of the lattices 42a and the lattices 42b.

When the conductive film for touch panel adopts the embodiment according to the aforementioned modification example, it is preferable in view of visibility.

### Second Embodiment

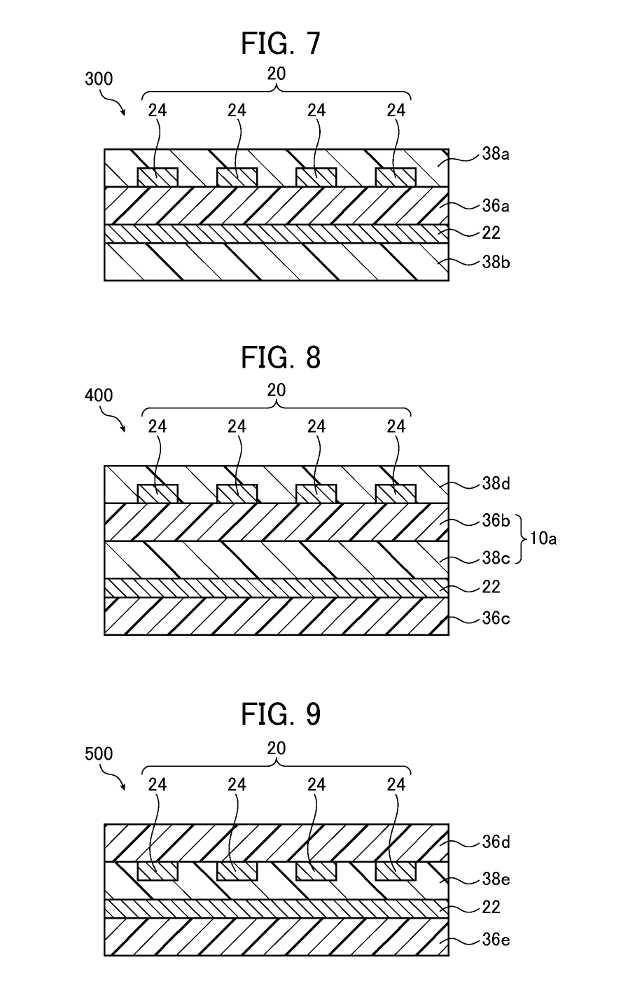

A second embodiment of the conductive film for touch panel of the present invention will be described with reference to the drawings. FIG. 7 is a cross-sectional view of the second embodiment of the conductive film for touch panel of the present invention.

As shown in FIG. 7, a conductive film for touch panel 300 includes a non-adhesive insulating layer 36a, the first electrode pattern 20 and an adhesive insulating layer 38a that are disposed on the main surface at one side of the non-adhesive insulating layer 36a, and the second electrode pattern 22 and an adhesive insulating layer 38b that are disposed on the main surface at the other side of the non-adhesive insulating layer 36a. As shown in FIGS. 1A and 1B, the first electrode pattern 20 and the second electrode pattern 22 extend in the X-direction and the Y-direction respectively, and are orthogonal to each other in a state in which the non-adhesive insulating layer 36a is interposed therebetween. The conductive film for touch panel 300 is a conductive film used for a so-called projected capacitance type touch panel, and corresponds to a conductive film in which an electrode is provided on both surfaces of one substrate.

Similarly to the first embodiment, in the conductive film for touch panel 300, the rate of change in mutual capacitance (%) between the first electrode pattern 20 and the second electrode pattern 22 before and after performing the environmental test is within a range of 0% to 100%. Furthermore, a preferable embodiment thereof is as described above.

In addition, similarly to the first embodiment, the water absorption rate of the conductive film for touch panel 300 is equal to or less than 1.00%. The method for calculating the water absorption rate is the same as the method described in the first embodiment. Herein, the water absorption rate refers to the water absorption rate of the entire film including the adhesive insulating layers 38a and 38b.

The conductive film for touch panel 300 is manufactured by bonding an adhesive insulating layer to both the surface of the first electrode pattern (the surface of the first electrode pattern that is opposite to the side of the insulating layer) and the surface of the second electrode pattern (the surface of the second electrode pattern that is opposite to the side of the insulating layer) of the conductive film for touch panel of the first embodiment.

When the conductive film for touch panel 300 is used as a touch panel, a protective substrate may be further provided on the adhesive insulating layers 38a and 38b.

The material of the protective substrate is not particularly limited, and examples thereof include (meth)acrylic resins, polycarbonate resins, glass, polyethylene terephthalate resins, and the like. Among these, (meth)acrylic resins excellent in transparency and lightweight properties are preferable.

### Third Embodiment

A third embodiment of the conductive film for touch panel of the present invention will be described with reference to the drawings. FIG. 8 is a cross-sectional view of the third embodiment of the conductive film for touch panel of the present invention.

As shown in FIG. 8, a conductive film for touch panel 400 includes an insulating layer 10a that is composed of a plurality of layers including a non-adhesive insulating layer 36b and an adhesive insulating layer 38c; the first electrode pattern 20 and an adhesive insulating layer 38d that are disposed on the main surface at one side of the insulating layer 10a; and the second electrode pattern 22 and a non-adhesive insulating layer 36c that are disposed on the main surface at the other side of the insulating layer 10a. As shown in FIGS. 1A and 1B, the first electrode pattern 20 and the second electrode pattern 22 extend in the X-direction and the Y-direction respectively, and are orthogonal to each other in a state in which the insulating layer 10a is interposed therebetween. The conductive film for touch panel 400 is manufactured in a manner in which two electrode pattern-equipped non-adhesive insulating layers are prepared; the two electrode pattern-equipped non-adhesive insulating layers are bonded to each other via an adhesive sheet such that the electrode patterns become orthogonal to each other; and an adhesive insulating layer is bonded onto the exposed electrode pattern.

Similarly to the first embodiment, in the conductive film for touch panel 400, the rate of change in mutual capacitance (%) between the first electrode pattern 20 and the second electrode pattern 22 before and after performing the environmental test is within a range of 0% to 100%. Furthermore, a preferable embodiment thereof is as described above.

In addition, similarly to the first embodiment, the water absorption rate of the conductive film for touch panel 400 is equal to or less than 1.00%. Herein, the water absorption rate refers to the water absorption rate of the entire conductive film for touch panel 400.

### Fourth Embodiment

A fourth embodiment of the conductive film for touch panel of the present invention will be described with reference to the drawings. FIG. 9 is a cross-sectional view of the fourth embodiment of the conductive film for touch panel of the present invention.

As shown in FIG. 9, a conductive film for touch panel 500 includes an adhesive insulating layer 38e; the first electrode pattern 20 and a non-adhesive insulating layer 36d that are disposed on the main surface at one side of the adhesive insulating layer 38e; and the second electrode pattern 22 and a non-adhesive insulating layer 36e that are disposed on the main surface at the other side of the adhesive insulating layer 38e. As shown in FIGS. 1A and 1B, the first electrode pattern 20 and the second electrode pattern 22 extend in the X-direction and the Y-direction respectively, and are orthogonal to each other in a state in which the adhesive insulating layer 38e is interposed therebetween. The conductive film for touch panel 500 is manufactured in a manner in which two electrode pattern-equipped non-adhesive insulating layers are prepared; and the two electrode pattern-equipped non-adhesive insulating layers are bonded to each other via an adhesive sheet such that the electrode patterns become orthogonal to each other and face each other.

Similarly to the first embodiment, in the conductive film for touch panel 500, the rate of change in mutual capacitance (%) between the first electrode pattern 20 and the second electrode pattern 22 before and after performing the environmental test is within a range of 0% to 100%. Furthermore, a preferable embodiment thereof is as described above.

In addition, similarly to the first embodiment, the water absorption rate of the conductive film for touch panel 500 is equal to or less than 1.00%. Herein, the water absorption rate refers to the water absorption rate of the entire conductive film for touch panel 500.

### Fifth Embodiment

A fifth embodiment of the conductive film for touch panel of the present invention is a conductive film for touch panel in which at least one silver halide emulsion layer is formed on each of both surfaces of an insulating layer composed of a single layer or a plurality of layers including two or more layers; and the resultant is exposed to light and then developed such that the first electrode pattern is formed on the main surface at one side of the insulating layer, and the second electrode pattern is formed on the main surface at the other side of the insulating layer.

Herein, as a modification example of the fifth embodiment, there is a conductive film for touch panel obtained in a manner in which a first electrode pattern-equipped insulating layer having the first electrode pattern on one surface of the insulating layer and a second electrode pattern-equipped insulating layer having the second electrode pattern on the other surface of the insulating layer are bonded to each other via an adhesive insulating layer, such that the first electrode pattern in the first electrode pattern-equipped insulating layer and the second electrode pattern in the second electrode pattern-equipped insulating layer face each other, or the insulating layer in the first electrode pattern-equipped insulating layer and the second electrode pattern in the second electrode pattern-equipped insulating layer face each other. In such a conductive film for touch panel, the first electrode pattern and the second electrode pattern are electrode patterns obtained in a manner in which at least one silver halide emulsion layer is formed on the insulating layer; and the resultant is exposed to light and then developed, and subjected to a film curing treatment using a polyvalent metal salt.

Similarly to the first embodiment, in the conductive film for touch panel obtained according to the embodiment, the rate of change in mutual capacitance (%) between the first electrode pattern and the second electrode pattern before and after performing the environmental test is within a range of 0% to 100%. Furthermore, a preferable embodiment thereof is as described above.

In addition, similarly to the first embodiment, the water absorption rate of the conductive film for touch panel is preferably equal to or less than 1.00%, more preferably 0% to 0.95%, even more preferably 0% to 0.90%, and particularly preferably 0% to 0.80%.

The manufacturing method of the conductive film for touch panel of the fifth embodiment in which an electrode pattern is provided on both surfaces of the insulating layer has a step (1) of forming a silver halide emulsion layer (hereinafter, simply referred to as a “photosensitive layer” in some cases) containing silver halide and a binder on both surfaces of an insulating layer, and a step (2) of exposing the photosensitive layer to light and then performing a development treatment on the photosensitive layer so as to form the thin conductive wires and form the first electrode pattern and the second electrode pattern.

Hereinafter, each of the steps will be described.

[Step (1): Step of Forming Photosensitive Layer]

Step (1) is a step of forming a photosensitive layer containing silver halide and a binder on both surfaces of an insulating layer.

The method for forming the photosensitive layer is not particularly limited. However, in view of productivity, a method is preferable in which a composition for forming a photosensitive layer containing silver halide and a binder is brought into contact with an insulating layer such that a photosensitive layer is formed on both surfaces of the insulating layer.

Hereinafter, embodiments of the composition for forming a photosensitive layer used in the aforementioned method will be described in detail, and then the procedure of the step will be described in detail.

The composition for forming a photosensitive layer contains silver halide and a binder.

The halogen element contained in the silver halide may be any of chlorine, bromine, iodine, and fluorine, and these may be used in combination. As the silver halide, for example, silver halide containing silver chloride, silver bromide, or silver iodide as a main component is preferably used, and silver halide containing silver bromide or silver chloride as a main component is more preferably used.

The types of the binder used are as described above. The binder may be contained in the composition for forming a photosensitive layer, in the form of latex.

The volume ratio between the silver halide and the binder contained in the composition for forming a photosensitive layer is not particularly limited, and is appropriately adjusted so as to fall within the aforementioned preferable range of the volume ratio between the metal and the binder in the thin conductive wires.

If necessary, the composition for forming a photosensitive layer contains a solvent.

Examples of the solvent used include water, organic solvents (for example, alcohols such as methanol, ketones such as acetone, amides such as formamide, sulfoxides such as dimethyl sulfoxide, esters such as ethyl acetate, and ethers), ionic liquids, and mixed solvents composed of these.

The content of the solvent used is not particularly limited. However, it is preferably within a range of 30% by mass to 90% by mass, and more preferably within a range of 50% by mass to 80% by mass, with respect to the total mass of the silver halide and the binder.

If necessary, the composition for forming a photosensitive layer may contain materials other than the aforementioned materials. Examples of such materials include metal compounds belonging to group VIII and VIIB, such as rhodium compounds and iridium compounds used to stabilize silver halide or to improve sensitivity of silver halide. Examples of such materials also include an antistatic agent, a nucleating agent, a spectral sensitizing dye, a surfactant, an anti-fogging agent, a film hardening agent, a black spot inhibitor, a redox compound, a monomethine compound, dihydroxybenzenes, and the like described in paragraphs [0220] to [0241] of JP 2009-004348 A.

(Procedure of Step)

The method of bringing the composition for forming a photosensitive layer into contact with the insulating layer is not particularly limited, and a known method can be adopted. Examples of the method include a method of coating the insulating layer with the composition for forming a photosensitive layer, a method of dipping the insulating layer into the composition for forming a photosensitive layer, and the like.

The content of the binder in the formed photosensitive layer is not particularly limited, and is preferably 0.3 g/m² to 5.0 g/m², and more preferably 0.5 g/m² to 2.0 g/m².

The content of the silver halide in the photosensitive layer is not particularly limited. However, because the conductivity of the thin conductive wires is further improved, the content thereof is preferably 1.0 g/m² to 20.0 g/m², and more preferably 5.0 g/m² to 15.0 g/m² expressed in terms of silver.

If necessary, a protective layer composed of the binder may be further provided on the photosensitive layer. If the protective layer is provided, scratches are prevented, or dynamic characteristics are improved.

[Step (2): Step of Exposure and Development]

Step (2) is a step of pattern-wisely exposing the photosensitive layer obtained in the step (1) to light and performing a development treatment on the photosensitive layer so as to form the thin conductive wires and form the first electrode pattern and the second electrode pattern.

Hereinafter, first, the pattern exposure treatment will be described in detail, and then the development treatment will be described in detail.

(Pattern Exposure)

When the photosensitive layer is pattern-wisely exposed to light, the silver halide in the photosensitive layer in the exposed region forms a latent image. In the region in which the latent image is formed, thin conductive wires are formed by the development treatment which will be described later. In contrast, in the unexposed region that is not exposed to light, the silver halide is dissolved and flows out of the photosensitive layer at the time of the fixing treatment, which will be described later, and thus a transparent film is obtained.

The light source used for exposure is not particularly limited, and examples thereof include light such as visible rays and ultraviolet rays, radiation such as X-rays, and the like.

The method for performing the pattern exposure is not particularly limited. For example, the pattern exposure may be performed by either surface exposure using a photomask or scanning exposure using laser beams. Herein, the form of the pattern is not particularly limited and appropriately adjusted according to the intended pattern of the thin conductive wires to be formed.

At the time of exposure, the photosensitive layers on both surfaces of the insulating layer may be simultaneously exposed to light (double-sided simultaneous exposure). In this type of exposure treatment, a first photosensitive layer disposed on the main surface at one side of the insulating layer is subjected to a first exposure treatment in which the insulating layer is irradiated with light such that the first photosensitive layer is exposed to the light along a first exposure pattern; and a second photosensitive layer disposed on the main surface at the other side of the insulating layer is subjected to a second exposure treatment in which the insulating layer is irradiated with light such that the second photosensitive layer is exposed to the light along a second exposure pattern.

More specifically, in a state in which a long photosensitive material is being transported in one direction, the first photosensitive layer is irradiated with a first light (parallel light) via a first photomask, and the second photosensitive layer is irradiated with a second light (parallel light) via a second photomask. The first light is obtained by converting the light emitted from a first light source into parallel light by using a first collimator lens disposed midway between the first light source and the first photosensitive layer. The second light is obtained by converting the light emitted from a second light source into parallel light by using a second collimator lens disposed midway between the second light source and the second photosensitive layer.

In the above description, a case in which two light sources (the first light source and the second light source) are used was illustrated. However, the light emitted from one light source may be divided by an optical system and may be radiated as the first light and the second light to the first photosensitive layer and the second photosensitive layer.

In the first exposure treatment and the second exposure treatment, the emission of the first light from the first light source and the emission of the second light from the second light source may be performed at the same time or different time. If the lights are emitted at the same timing, the first photosensitive layer and the second photosensitive layer can be simultaneously exposed to the respective lights by a single exposure treatment, hence the treatment time can be shortened. Meanwhile, in the case in which neither the first photosensitive layer nor the second photosensitive layer has been subjected to spectral sensitization, if both the layers are exposed to light, the exposure performed at one of the layers influences the image formation at the other layer (layer at the rear side).

That is, the first light having reached the first photosensitive layer from the first light source is scattered by the silver halide particles in the first photosensitive layer and transmitted through the insulating layer in the form of scattered light, and a portion of the scattered light reaches the second photosensitive layer. As a result, the boundary portion between the second photosensitive layer and the insulating layer is exposed to the scattered light over a wide range, and a latent image is formed. Consequentially, the second photosensitive layer is exposed to the second light from the second light source and the first light from the first light source. Therefore, when the second photosensitive layer is subjected to the development treatment thereafter, in addition to conductive pattern resulting from the second exposure pattern, a thin conductive layer resulting from the first light emitted from the first light source is formed between the conductive patterns, and accordingly, intended pattern (pattern according to the second exposure pattern) cannot be obtained. This phenomenon occurs in the first photosensitive layer in the same manner.

As a result of performing an intensive examination to avoid such a problem, it was found that by setting the thickness of the first photosensitive layer and the second photosensitive layer within a certain range or by specifying the amount of silver used for coating the first photosensitive layer and the second photosensitive layer, it is possible to make the silver halide absorb light and to restrict transmission of light to the rear surface. The thickness of the first photosensitive layer and the second photosensitive layer can be set to be equal to or greater than 1 μm and equal to or less than 4 μm, and the value of upper limit thereof is preferably 2.5 μm. The amount of silver used for coating the first photosensitive layer and the second photosensitive layer is specified within a range of 5 g/m² to 20 g/m².

The aforementioned double-side contact exposure mode has a problem of image defects induced by hindrance to exposure caused by dust or the like adhering to the surface of the sheet. As a method for preventing adherence of dust, a method of coating the sheet with a conductive substance is known. However, metal oxide and the like remain even after such a treatment is performed, and thus the transparency of the final product is impaired. Moreover, with this method, a conductive polymer has problems with storability or the like. As a result of conducting intensive examination to solve the problems, it was found that if silver halide is used in a state in which the amount of the binder is reduced, conductivity necessary for exerting an antistatic effect can be obtained. Based on this finding, the volume ratio of silver/binder in the first photosensitive layer and the second photosensitive layer was specified. That is, the volume ratio of silver/binder in the first photosensitive layer and the second photosensitive layer is equal to or higher than 1/1, and preferably equal to or higher than 2/1.

As described above, if the thickness of the first photosensitive layer and the second photosensitive layer, the amount of silver used for coating those layers, and the volume ratio of silver/binder in those layers are set and specified, the first light having reached the first photosensitive layer from the first light source cannot reach the second photosensitive layer. Likewise, the second light having reached the second photosensitive layer from the second light source cannot reach the first photosensitive layer. Consequentially, when the development treatment is performed thereafter, intended patterns can be obtained.

(Development Treatment)

The method of development treatment is not particularly limited, and known methods can be adopted. For example, it is possible to use general technologies of the development treatment used for silver halide photographic films, photographic printing paper, films for making printing plate, emulsion masks for photomask, and the like.

The type of the developer used for the development treatment is not particularly limited, and for example, it is possible to use a PQ developer, an MQ developer, an MAA developer, and the like. As commercially available products, for example, it is possible to use developers such as CN-16, CR-56, CP45X, FD-3, and Papitol formulated by FUJIFILM Corporation, C-41, E-6, RA-4, D-19, and D-72 formulated by KODAK, and developers included in the kit thereof. Furthermore, it is possible to use a lithographic developer.

The development treatment can include a fixing treatment performed for stabilization by removing silver halide in an unexposed portion. For the fixing treatment, it is possible to use technologies of the fixing treatment used for silver halide photographic films, photographic printing paper, films for making printing plates, emulsion masks for phosomask, and the like.

In the fixing treatment, the fixing temperature is preferably about 20° C. to about 50° C., and more preferably 25° C. to 45° C. The fixing time is preferably 5 seconds to 1 minute, and more preferably 7 seconds to 50 seconds.

The mass of metal silver contained in the exposed portion (thin conductive wire) having undergone the development treatment is preferably equal to or greater than 50% by mass, and more preferably equal to or greater than 80% by mass, with respect to the mass of silver contained in the exposed portion having not yet been exposed to light. If the mass of silver contained in the exposed portion is equal to or greater than 50% by mass with respect to the mass of silver contained in the exposed portion having not yet been exposed to light, it is preferable since a high degree of conductivity can be obtained.

If necessary, in addition to the aforementioned steps, the following step of forming an undercoat layer, step of forming an anti-halation layer, step of curing film, or heating treatment may be performed.

(Step of Forming Undercoat Layer)

Because the adhesiveness between the insulating layer and the silver halide emulsion layer becomes excellent, it is preferable to perform a step of forming a binder-containing undercoat layer on both surfaces of the insulating layer before step (1).

The binder used in this step is as described above. The thickness of the undercoat layer is not particularly limited. However, because the adhesiveness is further improved, and the rate of change in mutual capacitance is further reduced, the thickness thereof is preferably 0.01 μm to 0.5 μm, and more preferably 0.01 μm to 0.1 μm.

(Step of Forming Anti-Halation Layer)

From the viewpoint of making thinner conductive wires, it is preferable to perform a step of forming an anti-halation layer on both surfaces of the insulating layer before step (1).

Regarding the material used for the anti-halation layer, description of paragraphs [0029] to [0032] of JP 2009-188360 A can be referred to.

Because the rate of change in mutual capacitance is further reduced, and the migration resistance between electrode patterns becomes excellent, the anti-halation layer preferably contains a crosslinking agent. As the crosslinking agent, any of organic film hardening agents and inorganic film hardening agents can be used. However, from the viewpoint of controlling film curing, organic film hardening agents are preferable, and specific examples thereof include aldehydes, ketones, carboxylic acid derivatives, sulfonic acid esters, triazines, active olefins, isocyanate, and carbodiimide.

(Step of Film Hardening Treatment)

Because the rate of change in mutual capacitance is further reduced, and the migration resistance between electrode patterns becomes excellent, after step (2), it is preferable to perform a step of film hardening treatment by dipping the film in a solution in which a film hardening agent is dissolved. Specific examples of the film hardening agent include those described in JP 2-141279 A, such as inorganic salts, dialdehydes such as glutaraldehyde, adipaldehyde, and 2,3-dihydroxy-1,4-dioxane, and boric acid. Among these, inorganic salts are preferable, and polyvalent metal salts are more preferable.

Examples of metal atoms (metal ions) contained in the inorganic salts include alkali metals, alkaline earth metals, transition elements, base metals, and the like. Among these, because the rate of change in mutual capacitance is further reduced, and the migration resistance of the thin conductive wires becomes excellent, polyvalent metal salts are preferable, and aluminum atom-containing salts (inorganic salts) are more preferable.

Examples of counter anions contained in the inorganic salts include sulfate ions, phosphate ions, nitrate ions, acetate ions, and the like, and among these, sulfate ions are preferable.

Specific examples of the polyvalent metal salts include sulfate, nitrate, formate, succinate, malonate, chloroacetate, and p-toluenesulfonate of aluminum, calcium, magnesium, zinc, iron, strontium, barium, nickel, copper, scandium, gallium, indium, titanium, zirconium, tin, lead, and the like. More specific examples thereof include aluminum sulfate, aluminum chloride, potash alum, and the like.

The solvent in which the film hardening agent is dissolved is not particularly limited. However, in view of solubility and permeability with respect to the film, water is preferable.

The concentration of the film hardening agent in the solution in which the film hardening agent is dissolved is not particularly limited. However, the amount of aluminum atoms is preferably 0.01% by mass to 0.4% by mass with respect to the total amount of the solution in which the film hardening agent is dissolved.

(Step (3): Step of Heating)

Step (3) is a step of performing a heating treatment after the development treatment. By performing this step, the binders are fused with each other, and the hardness of the thin conductive wires is further increased. Particularly, when polymer particles are dispersed as the binder in the composition for forming a photosensitive layer (when the binder is a polymer particle in latex), by performing this step, the polymer particles are fused with each other, and thin conductive wires exhibiting an intended hardness are formed.

The conditions of the heating treatment are appropriately set according to the binder used. However, from the viewpoint of the film formation temperature of the polymer particles, the heating treatment is preferably performed at a temperature equal to or higher than 40° C., more preferably performed at a temperature equal to or higher than 50° C., and even more preferably performed at a temperature equal to or higher than 60° C. Furthermore, from the viewpoint of inhibiting curling or the like of the insulating layer, the heating treatment is preferably performed at a temperature equal to or less than 150° C., and more preferably performed at a temperature equal to or less than 100° C.

The heating time is not particularly limited. However, from the viewpoint of inhibiting curling or the like of the insulating layer and the viewpoint of productivity, the heating time is preferably 1 minute to 5 minutes, and more preferably 1 minute to 3 minutes.

Generally, the heating treatment can also function as a step of drying that is performed after the exposure and development treatment. Therefore, a new step does not need to be additionally performed for forming a film of polymer particles, and as a result, it is excellent in view of productivity, cost, and the like.

By performing the aforementioned step, a binder-containing light transmitting portion is formed between the thin conductive wires. The transmittance in the light transmitting portion that is expressed as the minimum transmittance in a region of a wavelength of 380 nm to 780 nm is preferably equal to or higher than 90%, more preferably equal to or higher than 95%, even more preferably equal to or higher than 97%, particularly preferably equal to or higher than 98%, and most preferably equal to or higher than 99%.

The light transmitting portion may contain materials other than the binder, and examples thereof include a poor solvent for silver and the like.

If the poor solvent for silver is contained in the light transmitting portion, ion migration of a metal caused between the thin conductive wires can be further inhibited. pKsp of the poor solvent for silver is preferably equal to or greater than 9, and more preferably 10 to 20. The poor solvent for silver is not particularly limited, and examples thereof include triethylenetetramine hexaacetic acid (TTHA) and the like.

The solubility product Ksp of silver is an index of the intensity of interaction among those compounds and silver ions. The Ksp can be measured with reference to the methods described in “Yoshikata Sakaguchi and Shinichi Kikuchi, Journal of The Society of Photography and Imaging of Japan, 13, 126, (1951)” and “A. Pailliofet and J. Pouradier, Bull. Soc. Chim. France, 1982, 1-445 (1982)”.

Herein, examples of the most preferable embodiment of the conductive film for touch panel of the present invention include the fifth embodiment described above. Particularly, as a conductive film for touch panel capable of further inhibiting the occurrence of operation failure, a conductive film for touch panel is mentioned in which at least one silver halide emulsion layer is formed on each of both surfaces of an insulating layer; each of the silver halide emulsion layers formed is exposed to light and then developed; and a film hardening treatment using a salt containing aluminum atoms is further performed thereon, such that the first electrode pattern is formed on the main surface at one side of the insulating layer, and the second electrode pattern is formed on the main surface at the other side of the insulating layer. In such a conductive film for touch panel, an adhesive insulating layer is further provided on at least one of the first electrode pattern and the second electrode pattern; an acid value of an adhesive insulating material contained in the adhesive insulating layer is equal to or greater than 10 mg KOH/g and equal to or less than 100 mg KOH/g; either or both of the first electrode pattern and the second electrode pattern contain silver; and the rate of change in mutual capacitance (%) between the first electrode pattern and the second electrode pattern before and after performing the environmental test is 0% to 100%.

The adhesive insulating layer particularly preferably contains a metal corrosion inhibitor.

[Touch Panel]

The touch panel of the present invention is a capacitance type touch panel and includes the conductive film for touch panel of the present invention. The touch panel of the present invention includes the conductive film for touch panel of the present invention. Accordingly, as described above, the rate of change in mutual capacitance (%) thereof is within a certain range, and as a result, operation failure thereof is inhibited.

Needless to say, the conductive film for touch panel and the touch panel of the present invention are not limited to the aforementioned embodiments, and various constituents can be adopted within a scope that does not depart from the gist of the present invention. Furthermore, the present invention can be used by being appropriately combined with the technologies disclosed in JP 2011-113149 A, JP 2011-129501 A, JP 2011-129112 A, JP 2011-134311 A, JP 2011-175628 A, and the like.

### EXAMPLES

Hereinafter, the present invention will be more specifically described based on examples, but the present invention is not limited thereto.

### Synthesis Example 1

18.3 parts of isobutyl acrylate, 73.2 parts of 2-ethylhexyl acrylate, 3.6 parts of 2-hydroxyethyl acrylate, 5.0 parts of acrylic acid, and 100 parts of ethyl acetate were weighed and put into a 1,000 mL three-neck flask, and the mixture was stirred for 2 hours in a state in which nitrogen gas was being introduced thereinto. After oxygen in the polymerization system was thoroughly removed, 0.3 parts of azobisisobutyronitrile was added thereto, and the resultant was heated to 60° C. and then reacted for 10 hours. After the reaction ended, ethyl acetate was added to the reaction liquid such that the solid concentration thereof became 30 wt %, thereby obtaining an acrylic polymer solution. The acid value of the obtained acrylic polymer was 40 mg KOH/g, and the weight average molecular weight thereof was 480,000.

Next, 0.19 parts of 1,4-butanediol glycidyl ether was added to 100 parts of the acrylic polymer solution, and the solution was stirred for 15 minutes. By using this solution, bar coating was performed under the conditions by which the film thickness after drying became 50 μm, and the resultant was dried for 5 minutes at 80° C., thereby manufacturing an acrylic resin-based adhesive.

### Synthesis Example 2

An acrylic resin-based adhesive was manufactured according to the same procedure as in Synthesis example 1, except that 0.23 parts of hexamethylene diisocyanate was used instead of 1,4-butanediol glycidyl ether described in Synthesis example 1.

### Synthesis Example 3

An acrylic resin-based adhesive was manufactured according to the same procedure as in Synthesis example 1, except that 1,4-butanediol glycidyl ether used in Synthesis example 1 was not used.

### Synthesis Example 4

18.7 parts of isobutyl acrylate, 75.1 parts of 2-ethylhexyl acrylate, 3.7 parts of 2-hydroxyethyl acrylate, 2.5 parts of acrylic acid, and 100 parts of ethyl acetate were weighed and put into a 1,000 mL three-neck flask, and the mixture was stirred for 2 hours in a state in which nitrogen gas was being introduced thereinto.

After oxygen in the polymerization system was thoroughly removed, 0.3 parts of azobisisobutyronitrile was added thereto, and the resultant was heated to 60° C. and then reacted for 10 hours. After the reaction ended, ethyl acetate was added to the reaction liquid such that the solid concentration thereof became 30 wt %, thereby obtaining an acrylic polymer solution. The acid value of the obtained acrylic polymer was 20 mg KOH/g, and the weight average molecular weight thereof was 350,000.

Next, 0.19 parts of 1,4-butanediol glycidyl ether was added to 100 parts of the acrylic polymer solution, and the solution was stirred for 15 minutes. By using this solution, bar coating was performed under the conditions by which the film thickness after drying became 50 μm, and the resultant was dried for 5 minutes at 80° C., thereby manufacturing an acrylic resin-based adhesive.

### Synthesis Example 5

25.3 parts of isobornyl acrylate, 62.6 parts of 2-ethylhexyl acrylate, 3.1 parts of 2-hydroxyethyl acrylate, 9.0 parts of acrylic acid, and 100 parts of ethyl acetate were weighed and put into a 1,000 mL three-neck flask, and the mixture was stirred for 2 hours in a state in which nitrogen gas was being introduced thereinto. After oxygen in the polymerization system was thoroughly removed, 0.3 parts of azobisisobutyronitrile was added thereto, and the resultant was heated to 60° C. and then reacted for 10 hours. After the reaction ended, ethyl acetate was added to the reaction liquid such that the solid concentration thereof became 30 wt %, thereby obtaining an acrylic polymer solution. The acid value of the obtained acrylic polymer was 70 mg KOH/g, and the weight average molecular weight thereof was 450,000.

Next, 0.19 parts of 1,4-butanediol glycidyl ether was added to 100 parts of the acrylic polymer solution, and the solution was stirred for 15 minutes. By using this solution, bar coating was performed under the conditions by which the film thickness after drying became 50 μm, and the resultant was dried for 5 minutes at 80° C., thereby manufacturing an acrylic resin-based adhesive.

### Synthesis Example 6

24.2 parts of isobornyl acrylate, 59.9 parts of 2-ethylhexyl acrylate, 3.0 parts of 2-hydroxyethyl acrylate, 12.9 parts of acrylic acid, and 100 parts of ethyl acetate were weighed and put into a 1,000 mL three-neck flask, and the mixture was stirred for 2 hours in a state in which nitrogen gas was being introduced thereinto. After oxygen in the polymerization system was thoroughly removed, 0.3 parts of azobisisobutyronitrile was added thereto, and the resultant was heated to 60° C. and then reacted for 10 hours. After the reaction ended, ethyl acetate was added to the reaction liquid such that the solid concentration thereof became 30 wt %, thereby obtaining an acrylic polymer solution. The acid value of the obtained acrylic polymer was 100 mg KOH/g, and the weight average molecular weight thereof was 400,000.

Next, 0.19 parts of 1,4-butanediol glycidyl ether was added to 100 parts of the acrylic polymer solution, and the solution was stirred for 15 minutes. By using this solution, bar coating was performed under the conditions by which the film thickness after drying became 50 μm, and the resultant was dried for 5 minutes at 80° C., thereby manufacturing an acrylic resin-based adhesive.

### Synthesis Example 7

23.5 parts of isobornyl acrylate, 58.2 parts of 2-ethylhexyl acrylate, 2.9 parts of 2-hydroxyethyl acrylate, 15.5 parts of acrylic acid, and 100 parts of ethyl acetate were weighed and put into a 1,000 mL three-neck flask, and the mixture was stirred for 2 hours in a state in which nitrogen gas was being introduced thereinto. After oxygen in the polymerization system was thoroughly removed, 0.3 parts of azobisisobutyronitrile was added thereto, and the resultant was heated to 60° C. and then reacted for 10 hours. After the reaction ended, ethyl acetate was added to the reaction liquid such that the solid concentration thereof became 30 wt %, thereby obtaining an acrylic polymer solution. The acid value of the obtained acrylic polymer was 120 mg KOH/g, and the weight average molecular weight thereof was 320,000.

Next, 0.19 parts of 1,4-butanediol glycidyl ether was added to 100 parts of the acrylic polymer solution, and the solution was stirred for 15 minutes. By using this solution, bar coating was performed under the conditions by which the film thickness after drying became 50 μm, and the resultant was dried for 5 minutes at 80° C., thereby manufacturing an acrylic resin-based adhesive.

### Synthesis Example 8

By using the urethane resin described in Synthesis example 2 of JP 4794691 B, a urethane-based polymer was obtained according to the same formulation and method as in Example 4 in JP 4794691 B.

Next, a urethane-based adhesive was manufactured according to the same procedure as in Synthesis example 1, except that the aforementioned urethane-based polymer was used instead of the acrylic polymer.

### Example 1

### Preparation of Silver Halide Emulsion

To the following Liquid 1 kept at 38° C. and pH 4.5, 90% of the following Liquid 2 and Liquid 3 were simultaneously added over 20 minutes while being stirred, thereby forming 0.16 μm of nuclear particles. Subsequently, the following Liquid 4 and Liquid 5 were added thereto over 8 minutes, and then the remaining 10% of the following Liquid 2 and Liquid 3 were added thereto over 2 minutes, such that the particles grew into 0.21 μm of particles. Thereafter, 0.15 g of potassium iodide was added thereto, the particles were allowed to mature for 5 minutes, and then the formation of particles was ended.

Liquid 1:

| | | |
|---|---|---|
| Water | 750 | ml |
| Gelatine | 9 | g |
| Sodium chloride | 3 | g |
| 1,3-Dimethylimidazolidine-2-thione | 20 | mg |
| Sodium benzene thiosulfonate | 10 | mg |
| Citric acid | 0.7 | g |

Liquid 2:

| | | |
|---|---|---|
| Water | 300 | ml |
| Silver nitrate | 150 | g |

Liquid 3:

| Water | 300 | ml |
|---|---|---|
| Sodium chloride | 38 | g |
| Potassium bromide | 32 | g |
| Potassium hexachloroiridate (III) | 8 | ml |
| (0.005% KCl 20% aqueous solution) | | |
| Ammonium hexachlororhodate | 10 | ml |

(0.001% NaCl 20% aqueous solution)

Liquid 4:

| | | |
|---|---|---|
| Water | 100 | ml |
| Silver nitrate | 50 | g |

Liquid 5:

| | | |
|---|---|---|
| Water | 100 | ml |
| Sodium chloride | 13 | g |
| Potassium bromide | 11 | g |
| Potassium ferrocyanide | 5 | mg |

Thereafter, according to a common method, the resultant was washed with water by a flocculation method. Specifically, the resultant was cooled to 35° C., and pH thereof was reduced by using sulfuric acid until the silver halide was precipitated (pH was within a range of 3.6±0.2). Next, about 3 L of supernatant liquid was removed (first washing with water). Subsequently, 3 L of distilled water was added thereto, and then sulfuric acid was added thereto until the silver halide was precipitated. Then 3 L of supernatant liquid was removed again (second washing with water). The same operation as the second washing with water was repeated once (third washing with water), and then the step of washing with water and demineralization was ended. pH of the emulsion obtained after the washing with water and demineralization was adjusted to 6.4 and pAg thereof was adjusted to 7.5. Next, by adding 3.9 g of gelatine, 10 mg of sodium benzene thiosulfonate, 3 mg of sodium benzene thiosulfinate, 15 mg of sodium thiosulfate, and 10 mg of chloroauric acid to the emulsion, chemical sensitization was performed on the emulsion such that the emulsion exhibited optimal sensitivity at 55° C. Thereafter, 100 mg of 1,3,3a,7-tetraazaindene as a stabilizer and 100 mg of Proxel (trade name, manufactured by ICI Co., Ltd.) as a preservative were added thereto. The finally obtained emulsion was an emulsion of cubic silver iodochlorobromide particles that contained 0.08 mol % of silver iodide and silver chlorobromide composed of silver chloride and silver bromide at a ratio of 70 mol % and 30 mol %, and had an average particle size of 0.22 μm and a coefficient of variation of 9%.

(Preparation of Composition for Forming Photosensitive Layer)

To the aforementioned emulsion, 1,3,3a,7-tetraazaindene in an amount of 1.2×10⁻⁴ mol/mol Ag, hydroquinone in an amount of 1.2×10⁻² mol/mol Ag, citric acid in an amount of 3.0×10⁻⁴ mol/mol Ag, and 2,4-dichloro-6-hydroxy-1,3,5-triazine sodium salt in an amount of 0.90 g/mol Ag were added. By using citric acid, pH of the coating liquid was adjusted to be 5.6, thereby obtaining a composition for forming a photosensitive layer.

(Step of Forming Photosensitive Layer)

A polyethylene terephthalate (PET) film having a thickness of 100 μm was subjected to a corona discharge treatment. Thereafter, on both surfaces of the PET film, a gelatine layer having a thickness of 0.1 μm was provided as an undercoat layer, and on the undercoat layer, an anti-halation layer, which has an optical density of about 1.0 and contains a dye that is bleached by alkali of a developer, was provided. The composition for forming a photosensitive layer was coated onto the anti-halation layer, and a gelatine layer having a thickness of 0.15 μm was provided thereon, thereby obtaining a PET film in which a photosensitive layer is formed on both surfaces thereof. The obtained film was named Film A. The formed photosensitive layer contains silver in an amount of 6.0 g/m² and gelatine in an amount of 1.0 g/m².

(Step of Exposure and Development)

Both surfaces of the Film A were subjected to exposure by using parallel light from a high-pressure mercury lamp as a light source, through a lattice-like photomask (line/space=8 μm/692 μm). After the exposure, the film was developed by using the following developer and further subjected to a development treatment by using a fixing solution (trade name: N3X-R for CN16X, manufactured by FUJIFILM Corporation). Thereafter, the film was rinsed with pure water and dried, thereby obtaining a PET film in which an electrode pattern composed of thin Ag wires and a gelatine layer are formed on both surfaces thereof. The gelatine layer was formed between the thin Ag wires. The obtained film was named Film B.

(Composition of Developer)

The following compounds are contained in 1 L of developer.

| | |
|---|---|
| Hydroquinone | 0.037 mol/L |
| N-methylaminophenol | 0.016 mol/L |
| Sodium metaborate | 0.140 mol/L |
| Sodium hydroxide | 0.360 mol/L |
| Sodium bromide | 0.031 mol/L |
| Potassium metabisulphite | 0.187 mol/L |

(Step of Heating)

The Film B was subjected to a heating treatment of 60° C./1 min. The film having undergone the heating treatment was named Film C.

(Step of Film Hardening Treatment)

The Film C was subjected to a film hardening treatment by being dipped in an aqueous aluminum sulfate solution (temperature: 30° C.) having a concentration of 3% by mass for 2 minutes. The film having undergone the film hardening treatment was named Film D.

(Step of Forming Adhesive Insulating Layer)

Onto both surfaces of the Film D, as an adhesive insulating material, the acrylic resin-based adhesive obtained in Synthesis example 1 was stuck, thereby obtaining a conductive film for touch panel.

(Measurement of Water Absorption Rate of Conductive Film for Touch Panel)

A PET film (thickness of 100 μm) was stuck on both surfaces of the obtained conductive film for touch panel. The resultant film was left to stand for 24 hours in an environment of a temperature of 85° C. and a humidity of 85% and then weighed (the mass obtained in this manner was maned Q1). Subsequently, the resultant film was dried for 24 hours in an environment of a temperature of 110° C. and then weighed (the mass obtained in this manner was named Q2).

Separately, a PET film having the same area as the total area of the PET films stuck on the conductive film for touch panel was left to stand for 24 hours in the aforementioned environment and then weighed (the mass obtained in this manner was named P1). Subsequently, the PET film was dried for 24 hours in an environment of a temperature of 110° C. and then weighed (the mass obtained in this manner was named P2).

The mass (W1) of only the conductive film for touch panel having been left to stand in the environment of a temperature of 85° C. and a humidity of 85% is equal to Q1−P1. Moreover, the mass (W2) of only the dried conductive film for touch panel is equal to Q2−P2.

The water absorption rate of the conductive film for touch panels was calculated by the following equation. The calculated water absorption rate is shown in Table 1.

Water absorption rate of conductive film for touch panel (%)=(W1−W2)/W2×100

(Rate of Change in Mutual Capacitance)

The obtained conductive film for touch panel was left to stand in an environment of a temperature of 25° C. and a humidity of 50% for 30 days. Thereafter, a mutual capacitance (X) between the first electrode pattern on one surface of the conductive film for touch panel and the second electrode pattern on the other surface thereof was calculated. Next, the conductive film for touch panel was left to stand in an environment of a temperature of 85° C. and a humidity of 85% for 30 days. Then a mutual capacitance (Y) between the first electrode pattern and the second electrode pattern was measured. The rate of change in mutual capacitance was calculated by the following equation. The calculated rate of change in mutual capacitance is shown in Table 1.

Rate of change in mutual capacitance (%)=(Y−X)/X×100

The mutual capacitance between the first electrode pattern and the second electrode pattern was measured by an LCR meter.

(Evaluation of Operation Failure)

A control IC was installed in the conductive film for touch panel, the conductive film for touch panel was left to stand in an environment of a temperature of 85° C. and a humidity of 85% for 30 days, and then the touch operation was confirmed. The operation failure was evaluated based on the following criteria.

“A”: Touch operation could be confirmed in all electrodes in the electrode pattern.

“B”: Touch operation could be confirmed in electrodes in a proportion of equal to or higher than 90% and less than 100% in the electrode pattern.

“C”: Touch operation could be confirmed in electrodes in a proportion of equal to or higher than 85% and less than 90% in the electrode pattern.

“D”: Touch operation could be confirmed in electrodes in a proportion of equal to or higher than 80% and less than 85% in the electrode pattern.

“E”: Touch operation could be confirmed in electrodes in a proportion of less than 80% in the electrode pattern.

(Measurement of Value of Insulation Resistance)

The obtained conductive film for touch panel was left to stand in an environment of a temperature of 85° C. and a humidity of 85% for 30 days, and then a value of insulation resistance thereof was measured. The measured value of insulation resistance is shown in Table 1. The value of insulation resistance was measured in the following manner.

For measuring the value of insulation resistance, 10 points (measurement points) were selected; the insulation resistances of these 10 points were measured by using an insulation resistance meter; and the average thereof was taken as the value of insulation resistance. The insulation resistance measured in each of measurement points is insulation resistance between thin Ag wires (sides of a lattice pattern that face each other) adjacent to each other. The greater the value of insulation resistance, the better the migration resistance.

### Example 2

A conductive film for touch panel was manufactured according to the same procedure as in Example 1, except that the acrylic resin-based adhesive of Synthesis example 2 was used instead of the acrylic resin-based adhesive of Synthesis example 1. The conductive film for touch panel was evaluated in the same manner as in Example 1. The results are summarized in Table 1.

### Example 3

A conductive film for touch panel was manufactured according to the same procedure as in Example 1, except that the acrylic resin-based adhesive of Synthesis example 3 was used instead of the acrylic resin-based adhesive of Synthesis example 1. The conductive film for touch panel was evaluated in the same manner as in Example 1. The results are summarized in Table 1.

### Example 4

A conductive film for touch panel was manufactured according to the same procedure as in Example 1, except that the acrylic resin-based adhesive of Synthesis example 4 was used instead of the acrylic resin-based adhesive of Synthesis example 1. The conductive film for touch panel was evaluated in the same manner as in Example 1. The results are summarized in Table 1.

### Example 5

A conductive film for touch panel was manufactured according to the same procedure as in Example 4, except that benzotriazole was further added in an amount of 0.8 wt % to the acrylic resin-based adhesive of Synthesis example 4. The conductive film for touch panel was evaluated in the same manner as in Example 1. The results are summarized in Table 1.

### Example 6

A conductive film for touch panel was manufactured according to the same procedure as in Example 4, except that tolyltriazole was further added in an amount of 0.8 wt % to the acrylic resin-based adhesive of Synthesis example 4. The conductive film for touch panel was evaluated in the same manner as in Example 1. The results are summarized in Table 1.

### Example 7

A conductive film for touch panel was manufactured according to the same procedure as in Example 1, except that the acrylic resin-based adhesive of Synthesis example 5 was used instead of the acrylic resin-based adhesive of Synthesis example 1. The conductive film for touch panel was evaluated in the same manner as in Example 1. The results are summarized in Table 1.

### Example 8

A conductive film for touch panel was manufactured according to the same procedure as in Example 1, except that the acrylic resin-based adhesive of Synthesis example 6 was used instead of the acrylic resin-based adhesive of Synthesis example 1. The conductive film for touch panel was evaluated in the same manner as in Example 1. The results are summarized in Table 1.

### Example 9

A conductive film for touch panel was manufactured according to the same procedure as in Example 1, except that the acrylic resin-based adhesive of Synthesis example 7 was used instead of the acrylic resin-based adhesive of Synthesis example 1. The conductive film for touch panel was evaluated in the same manner as in Example 1. The results are summarized in Table 1.

### Example 10

A conductive film for touch panel was manufactured according to the same procedure as in Example 1, except that an adhesive sheet NSS50 (manufactured by New Tac Kasei Co., Ltd., containing a hardening agent, thickness of 50 μm) was used instead of the acrylic resin-based adhesive of Synthesis example 1. The conductive film for touch panel was evaluated in the same manner as in Example 1. The results are summarized in Table 1.

### Example 11

A conductive film for touch panel was manufactured according to the same procedure as in Example 1, except that a highly transparent adhesive transfer tape 8146-2 (manufactured by 3M Company, containing a hardening agent, thickness of 50 μm) was used instead of the acrylic resin-based adhesive of Synthesis example 1. The conductive film for touch panel was evaluated in the same manner as in Example 1. The results are summarized in Table 1.

### Comparative Example 1

A conductive film for touch panel was manufactured according to the same procedure as in Example 1, except that the urethane-based adhesive of Synthesis example 8 was used instead of the acrylic resin-based adhesive of Synthesis example 1. The conductive film for touch panel was evaluated in the same manner as in Example 1. The results are summarized in Table 1.

### Comparative Example 2

Without performing the film hardening treatment, a conductive film for touch panel was manufactured according to the same procedure as in Example 1, and evaluated in the same manner as in Example 1. The results are summarized in Table 1.

### Comparative Example 3

Without performing the film hardening treatment, a conductive film for touch panel was manufactured according to the same procedure as in Example 1, except that an adhesive sheet NSS50 (manufactured by New Tac Kasei Co., Ltd., containing a hardening agent, thickness of 50 μm) was used instead of the acrylic resin-based adhesive of Synthesis example 1. The conductive film for touch panel was evaluated in the same manner as in Example 1. The results are summarized in Table 1.

### Comparative Example 4

Without performing the film hardening treatment, a conductive film for touch panel was manufactured according to the same procedure as in Example 1, except that a highly transparent adhesive transfer tape 8146-2 (manufactured by 3M Company, containing a hardening agent, thickness of 50 μm) was used instead of the acrylic resin-based adhesive of Synthesis example 1. The conductive film for touch panel was evaluated in the same manner as in Example 1. The results are summarized in Table 1.

(Measurement of Acid Value of Adhesive Insulating Material)

The acid values of the acrylic resin-based adhesives of Synthesis examples 1 to 7, the adhesive sheet NSS50 (manufactured by New Tac Kasei Co., Ltd.), and the highly transparent adhesive transfer tape 8146-2 (manufactured by 3M Company) were measured by neutralization titration method based on JIS K0070:1992 “Test methods for acid value, saponification value, ester value, iodine value, hydroxyl value, and unsaponifiable matter of chemical products”. The measured acid values are shown in Table 1.

In Table 1, “-” means that the acid value was not measured.

In Table 1, in the column of “whether or not film hardening treatment was performed”, “performed” is listed for the case in which the film hardening treatment was performed, and “not performed” is listed for the case in which the film hardening treatment was not performed.

TABLE 1

| (part 1) | | | | | | | | | | | | (part 2) | | | |
|---|---|---|---|---|---|---|---|---|---|---|---|---|---|---|---|
| | Example | Example | Example | Example | Example | Example | Example | Example | Example | Example | Example | Comparative | Comparative | Comparative | Comparative |
| | 1 | 2 | 3 | 4 | 5 | 6 | 7 | 8 | 9 | 10 | 11 | example 1 | example 2 | example 3 | example 4 |
| Adhesive | Synthesis | Synthesis | Synthesis | Synthesis | Synthesis | Synthesis | Synthesis | Synthesis | Synthesis | NSS50 | 8146-2 | Synthesis | Synthesis | NSS50 | 8146-2 |
| insulating | example | example | example | example | example | example | example | example | example | | | example | example | | |
| material | 1 | 2 | 3 | 4 | 4 | 4 | 5 | 6 | 7 | | | 8 | 1 | | |
| Acid value of | 36 | 35 | 40 | 16 | 16 | 16 | 66 | 96 | 116 | 34 | 6 | — | 36 | 34 | 6 |
| adhesive insulating | | | | | | | | | | | | | | | |
| material (mgKOH/g) | | | | | | | | | | | | | | | |
| Water absorption | 0.82 | 0.88 | 0.93 | 0.98 | 0.91 | 0.97 | 0.88 | 0.91 | 0.98 | 0.80 | 0.92 | 1.28 | 1.58 | 1.61 | 1.80 |
| rate of conductive | | | | | | | | | | | | | | | |
| film (%) | | | | | | | | | | | | | | | |
| Value of insulation | 5.5 | 4.7 | 4.0 | 3.2 | 5.4 | 5.5 | 5.1 | 4.9 | 4.5 | 6.0 | 4.1 | 2.0 | 1.5 | 1.3 | 0.7 |
| resistance (MΩ) | | | | | | | | | | | | | | | |
| Mutual | 1.2 | 1.1 | 1.1 | 1.2 | 1.1 | 1.2 | 1.2 | 1.2 | 1.2 | 1.1 | 1.1 | 1.3 | 1.2 | 1.1 | 1.1 |
| capacitance | | | | | | | | | | | | | | | |
| (pF) (before | | | | | | | | | | | | | | | |
| environmental | | | | | | | | | | | | | | | |
| test) | | | | | | | | | | | | | | | |
| Mutual | 1.6 | 1.6 | 1.9 | 2.2 | 2.0 | 2.2 | 1.8 | 1.8 | 1.9 | 1.4 | 1.9 | 3.5 | 4.5 | 4.2 | 4.5 |
| capacitance | | | | | | | | | | | | | | | |
| (pF) (after | | | | | | | | | | | | | | | |
| environmental | | | | | | | | | | | | | | | |
| test) | | | | | | | | | | | | | | | |
| Rate of change | 33 | 45 | 73 | 83 | 82 | 83 | 50 | 50 | 73 | 27 | 73 | 169 | 275 | 282 | 309 |
| in mutual | | | | | | | | | | | | | | | |
| capacitance (%) | | | | | | | | | | | | | | | |
| Whether or not | Per- | Per- | Per- | Per- | Per- | Per- | Per- | Per- | Per- | Per- | Per- | Per- | Not per- | Not per- | Not per- |
| film hardening | formed | formed | formed | formed | formed | formed | formed | formed | formed | formed | formed | formed | formed | formed | formed |
| treatment | | | | | | | | | | | | | | | |
| was performed | | | | | | | | | | | | | | | |
| Evaluatin | A | B | C | C | B | B | C | C | D | A | D | E | E | E | E |
| result of | | | | | | | | | | | | | | | |
| operation | | | | | | | | | | | | | | | |
| failure | | | | | | | | | | | | | | | |

As shown in Examples 1 to 11 in Table 1, when the rate of change in mutual capacitance was within a predetermined range, the occurrence of operation failure caused over time could be inhibited.

Moreover, as is evident from the comparison between Examples 9 and 11 and other examples, it was confirmed that when the acid value of the adhesive insulating material was 10 mg KOH/g to 100 mg KOH/g, the operation failure did not easily occur.

Furthermore, as is evident from the comparison among Examples 4 to 6, it was confirmed that when the adhesive insulating material contained the metal corrosion inhibitor, the operation failure did not easily occur.

In addition, as is evident from the comparison among Examples 1 to 4, it was confirmed that when the rate of change in mutual capacitance was 0% to 50%, the operation failure did not easily occur.

In addition, as is evident from the comparison among Examples 1 to 3 and 10, it was confirmed that when the water absorption rate of the conductive film was 0.85% by mass, the operation failure did not easily occur.

In contrast, as is evident from Comparative Examples 1 to 4, when the rate of change in mutual capacitance was out of a predetermined range, the operation failure frequently occurred, and thus intended effects were not obtained.

What is claimed is:

1. A conductive film for touch panel,
wherein at least one silver halide emulsion layer is formed on each of both surfaces of an insulating layer,
the silver halide emulsion layer formed on each of both surfaces of the insulating layer is exposed to light, then developed, and subjected to a film hardening treatment using a salt containing aluminum atoms, such that a first electrode pattern is formed on the main surface at one side of the insulating layer, and a second electrode pattern is formed on the main surface at the other side of the insulating layer,
an adhesive insulating layer is disposed on at least one of the first electrode pattern and the second electrode pattern,
an acid value of an adhesive insulating material contained in the adhesive insulating layer is equal to or greater than 10 mg KOH/g and equal to or less than 100 mg KOH/g,
either or both of the first electrode pattern and the second electrode pattern contain silver, and
a rate of change in mutual capacitance (%) between the first electrode pattern and the second electrode pattern before and after performing the following environmental test is 0% to 100%,
(An environmental test, in which the conductive film for touch panel is left to stand in an environment of a temperature of 85° C. and a humidity of 85% for 30 days, is performed; and by using a mutual capacitance (X) between the first electrode pattern and the second electrode pattern having not yet been subjected to the environmental test and a mutual capacitance (Y) between the first electrode pattern and the second electrode pattern having been subjected to the environmental test, the rate of change in mutual capacitance (%) is calculated by an equation of {(Y−X)/X×100}.

2. The conductive film for touch panel according to claim 1,
wherein the adhesive insulating layer contains a metal corrosion inhibitor.

3. A conductive film for touch panel comprising a first electrode pattern, an insulating layer, and a second electrode pattern in this order,
wherein a rate of change in mutual capacitance (%) between the first electrode pattern and the second electrode pattern before and after performing the following environmental test is 0% to 100%,
(An environmental test, in which the conductive film for touch panel is left to stand in an environment of a temperature of 85° C. and a humidity of 85% for 30 days, is performed; and by using a mutual capacitance (X) between the first electrode pattern and the second electrode pattern having not yet been subjected to the environmental test and a mutual capacitance (Y) between the first electrode pattern and the second electrode pattern having been subjected to the environmental test, the rate of change in mutual capacitance (%) is calculated by an equation of {(Y−X)/X×100}.

4. The conductive film for touch panel according to claim 3,
wherein the rate of change in mutual capacitance (%) is 0% to 50%.

5. The conductive film for touch panel according to claim 3, further comprising an adhesive insulating layer on at least one of the first electrode pattern and the second electrode pattern.

6. The conductive film for touch panel according to claim 3, further comprising an adhesive insulating layer on the first electrode pattern and the second electrode pattern,
wherein the insulating layer is a non-adhesive insulating layer.

7. The conductive film for touch panel according to claim 3,
wherein the insulating layer includes an adhesive insulating layer.

8. The conductive film for touch panel according to claim 5,
wherein an adhesive insulating material contained in the adhesive insulating layer includes an acrylic resin.

9. The conductive film for touch panel according to claim 5,
wherein an acid value of an adhesive insulating material contained in the adhesive insulating layer is equal to or greater than 10 mg KOH/g and equal to or less than 100 mg KOH/g.

10. The conductive film for touch panel according to claim 3,
wherein the insulating layer contains a metal corrosion inhibitor.

11. The conductive film for touch panel according to claim 10,
wherein the metal corrosion inhibitor is selected from the group consisting of triazole compounds, tetrazole compounds, benzotriazole compounds, benzimidazole compounds, thiadiazole compounds, and benzothiazole compounds.

12. The conductive film for touch panel according to claim 3 that has a water absorption rate of equal to or less than 1.0% when being left to stand in an environment of a temperature of 85° C. and a humidity of 85% for 24 hours.

13. The conductive film for touch panel according to claim 3,
wherein either or both of the first electrode pattern and the second electrode pattern contain silver.

14. The conductive film for touch panel according to claim 3,
wherein either or both of the first electrode pattern and the second electrode pattern are constituted with thin metal wires having a line width of equal to or less than 30 μm.

15. A conductive film for touch panel formed in a manner in which a first electrode pattern-equipped insulating layer having the first electrode pattern on one surface of the insulating layer and a second electrode pattern-equipped insulating layer having the second electrode pattern on one surface of the insulating layer are bonded to each other via an adhesive insulating layer, such that the first electrode pattern in the first electrode pattern-equipped insulating layer and the second electrode pattern in the second electrode pattern-equipped insulating layer face each other, or the insulating layer in the first electrode pattern-equipped insulating layer and the second electrode pattern in the second electrode pattern-equipped insulating layer face each other,
wherein each of the first electrode pattern and the second electrode pattern is electrode pattern formed in a manner in which at least one silver halide emulsion layer is formed on the insulating layer, and the silver halide emulsion layer is exposed to light, then developed, and subjected to a film hardening treatment using a polyvalent metal salt, and
a rate of change in mutual capacitance (%) between the first electrode pattern and the second electrode pattern before and after performing the following environmental test is 0% to 100%,
(An environmental test, in which the conductive film for touch panel is left to stand in an environment of a temperature of 85° C. and a humidity of 85% for 30 days, is performed; and by using a mutual capacitance (X) between the first electrode pattern and the second electrode pattern having not yet been subjected to the environmental test and a mutual capacitance (Y) between the first electrode pattern and the second electrode pattern having been subjected to the environmental test, the rate of change in mutual capacitance (%) is calculated by an equation of {(Y−X)/X×100}.

16. The conductive film for touch panel according to claim 15,
wherein the polyvalent metal salt is a salt containing aluminum atoms.

17. A touch panel comprising the conductive film for touch panel according to claim 1.

18. A touch panel comprising the conductive film for touch panel according to claim 2.

19. A touch panel comprising the conductive film for touch panel according to claim 3.

20. A touch panel comprising the conductive film for touch panel according to claim 15.
